(19) United States
(12) Patent Application Publication
(10) Pub. No.: US 2003/0137362 A1
(43) Pub. Date: Jul. 24, 2003

(54) Resonator, filter, duplexer, composite filter device, transmission-reception device, and communication device

(76) Inventors: Norifumi Matsui, Kyoto-shi (JP); Jun Hattori, Takatsuki-shi (JP)

Correspondence Address: Richard LaCava, DICKSTEIN SHAPIRO MORIN & OSHINSKY LLP, 41st Floor, 1177 Avenue of the Americas, New York, NY, 10036-2714, US

(21) Appl. No.: 10/338,023

(22) Filed: Jan. 8, 2003

(30) Foreign Application Priority Data
Jan. 8, 2002 (JP) 2002-001791

(51) Int. Cl. H01P 1/213; H01P 1/205; H01P 7/04; H01B 12/02

(52) U.S. Cl. 333/99 S; 333/202; 333/134; 333/222; 505/210

(57) ABSTRACT

In a dielectric block having a through-hole, an outer surface electrode is formed on the outer surface of the dielectric block excluding the outer surfaces having the openings of the through-hole, and an inner surface electrode is formed on the inner surface of the through-hole. The dielectric block is made of a dielectric of which the dielectric constant having a negative temperature coefficient, that is, the dielectric constant increases as the temperature decreases. The inner surface electrode is formed by lamination of a superconductor film and a metallic film, and similarly, the outer surface electrode is formed by lamination of a superconductor film and a metallic film.

### BACKGROUND OF THE INVENTION

1. Field of the Invention

The present invention relates to a dielectric resonator, a filter, a duplexer, a composite filter device, a transmission-reception device, and a communication device using the same.

2. Description of the Related Art

A related art dielectric resonator will be described with reference to FIG. 8.

FIG. 8A is a perspective view of the dielectric resonator. FIG. 8B is an enlarged cross-sectional view of the outer surface electrode of the dielectric resonator. FIG. 8C is an enlarged cross-sectional view of the inner surface electrode of the dielectric resonator.

In FIG. 8, a dielectric block 11, a through-hole 12, an inner surface electrode 13, and an outer surface electrode 14 are shown.

As shown in FIG. 8, the through-hole 12 having the inner surface electrode 13 is formed so as to extend from one face of the block 11 to the opposite face thereof. The outer surface electrode 14 is formed on the outer surface of the dielectric block 11 excluding the openings of the through-hole 12. The length of the dielectric block in the direction parallel to the through-hole 12 is set at half the wavelength of a transmission signal. Thus, a half-wave dielectric resonator is formed.

The inner surface electrode 13 and the outer surface electrode 14 are made of a metal such as Ag, Au, or the like.

The above-described related art dielectric resonator has the following problems.

To reduce the loss of a resonator, a dielectric resonator using a superconductor for the inner and outer surface electrodes thereof has been devised. In the case where the superconductor is used for the inner and outer surface electrodes, the conductor loss is low, and the obtained characteristics are superior below the transition temperature of the superconductor. On the contrary, the conductor loss is considerably increased, and the characteristics are deteriorated above the transition temperature. Furthermore, the surface impedance of the superconductor is changed, and hence, the resonance frequency is also changed.

In a dielectric resonator device in which a TE mode dielectric resonator is arranged in a cavity having the surface made of a super conductor, the temperature dependency can be corrected by arrangement of a dielectric in which the temperature coefficient of the dielectric constant is negative in addition to the main dielectric member of the device. For this type dielectric resonator device, the temperature dependence can be improved when the temperature of the device is below the superconduction transition temperature. However, the problems such as increase of the loss, frequency variation, and so forth can not be solved when the temperature of the device is below the superconduction transition temperature. Moreover, the size of the device is large, and the number of parts is increased. Thus, the cost of the device becomes high.

### SUMMARY OF THE INVENTION

Accordingly, it is an object of the present invention to provide a filter, a duplexer, a composite filter device, a transmission-reception device, and a communication device in which the temperature dependence of the resonance frequency is improved, the loss is low, and the structure is simple.

According to the present invention, there is provided a resonator in which the dielectric has a dielectric constant with a negative temperature coefficient, and the electrodes are composite electrodes made of a superconductor and a metal. Thus, the resonance frequency is substantially constant in a wide temperature range, and the loss is low.

Preferably, a dielectric block having a dielectric constant with a negative temperature coefficient is used, and an inner surface electrode and an outer surface electrode formed by sequential lamination of a superconductor film and a metallic film on the outer surface of the dielectric block in that order are provided. Thus, the resonance frequency is substantially constant in a wide temperature range from a low temperature to about ordinary temperature.

Preferably, an external unit comprising a dielectric block and an electrode formed on the outer surface of the dielectric block by sequential lamination of a super conductor film and a metallic film onto the surface of the dielectric block in that order, and an internal unit comprising a rod member having an electrode formed by sequential lamination of a super conductor film and a metallic film on the side surface of the rod member in that order are formed. The external unit and the internal unit are combined to form a dielectric resonator. The electrodes can be formed with high precision, and the loss of the resonator is low.

Preferably, the electrodes are formed using the dielectric block, the superconductor film, and the metallic film in such a manner that the resonance frequency at the transition temperature of the super conductor film or lower is substantially equal to that at the transition temperature or higher.

Also, preferably, a filter comprises at least two sets of the above-described resonators and arranged, and inputting-outputting means coupled to predetermined resonators, respectively. The filter has a superior attenuation characteristic and a low loss.

Preferably, a filter comprises the dielectric block and plural through-holes provided with the inner surface electrodes, respectively, and the resonators are composed of the inner surface electrodes, the outer surface electrode, and the dielectric block, respectively, and the filter is provided with inputting-outputting means coupled to predetermined resonators, respectively. Thus, the attenuation characteristic is high, and the loss is low. In addition, the size of the integrated filter is small.

Preferably, the filter comprises the external unit provided with plural through-holes for accommodating plural internal units, respectively, the internal units are arranged in the through-holes to form plural resonators, respectively, and the inputting-outputting means to be coupled to predetermined dielectric resonators. The electrodes can be formed at high precision, and the filter has a superior attenuation characteristic and a low loss.

Also, preferably, a duplexer comprises the filters provided between a transmission signal input port and a transmission-reception input-output port and between the transmission-reception input-output port and a reception signal output port as a transmission filter and a reception filter, respectively. The duplexer has superior communication characteristics.

Preferably, a composite filter device comprises at least two sets of filters each containing the above-described resonator. The composite filter device has superior communication characteristics.

### BRIEF DESCRIPTION OF THE DRAWINGS

FIG. 1A is a perspective view of a dielectric resonator according to a first embodiment of the present invention;

FIG. 1B is an enlarged cross-sectional view of the outer surface electrode of the dielectric resonator;

FIG. 1C is an enlarged cross-sectional view of the inner surface electrode;

FIG. 2A is a graph showing the temperature characteristic of the resonance frequency obtained when the temperature coefficient of the dielectric constant of a dielectric is zero;

FIG. 2B is a graph showing the temperature characteristic of the resonance frequency obtained when the temperature coefficient of the dielectric constant of a dielectric is negative;

FIG. 3A is a perspective view of a dielectric resonator according to a second embodiment of the present invention;

FIG. 3B is an exploded perspective view of the resonator;

FIG. 3C is an enlarged cross-sectional view of the outer surface electrode of the resonator;

FIG. 3D is an enlarged cross-sectional view of the inner surface electrode of the resonator;

FIG. 4 is a perspective view of a filter according to a third embodiment of the present invention;

FIG. 5 is a perspective view of a duplexer according to a fourth embodiment of the present invention;

FIG. 6 is a diagram schematically showing a low temperature reception device according to a fifth embodiment of the present invention;

FIG. 7 is a block diagram of a communication device according to a sixth embodiment of the present invention;

FIG. 8A is a perspective view of a related art dielectric resonator;

FIG. 8B is an enlarged cross-sectional view of the outer surface electrode of the dielectric resonator; and

FIG. 8C is an enlarged cross-sectional view of the inner surface electrode.

### DESCRIPTION OF THE PREFERRED EMBODIMENTS

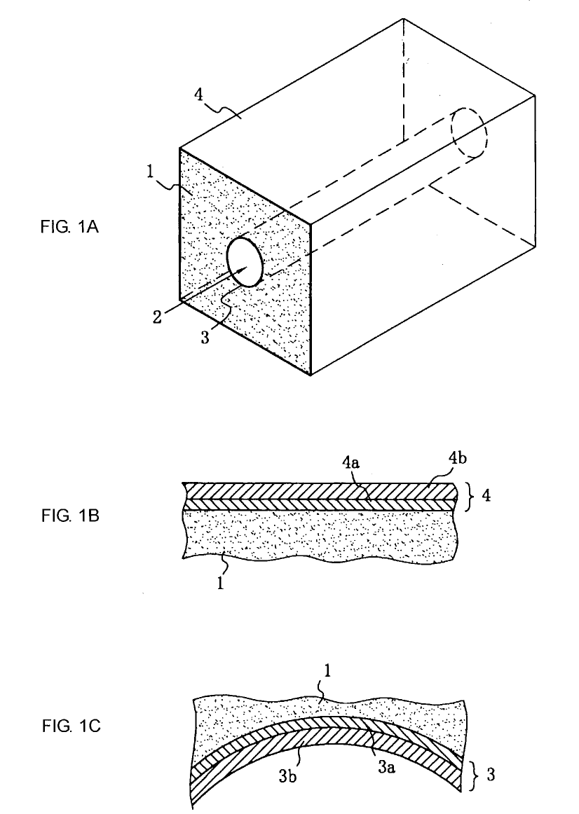

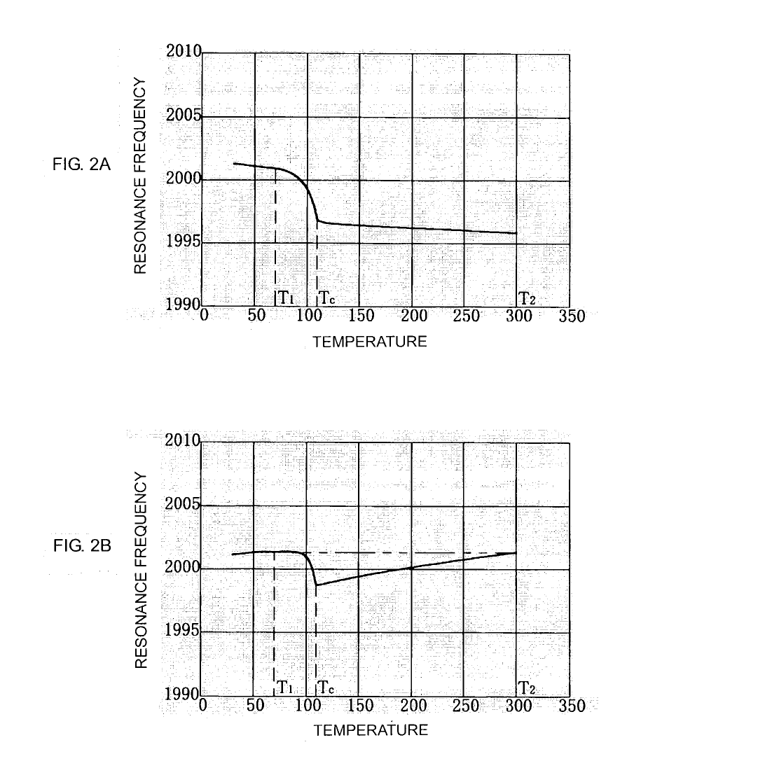

A dielectric resonator according to a first embodiment of the present invention will be described with reference to FIGS. 1A, 1B, 1C, 2A, and 2B.

FIG. 1A is a perspective view of a dielectric resonator. FIG. 1B is an enlarged cross-sectional view of the outer surface electrode of the dielectric resonator. FIG. 1C is an enlarged cross-sectional view of the inner surface electrode of the dielectric resonator.

In FIG. 1, a dielectric block 1, a through-hole 2, an inner surface electrode 3, an outer surface electrode 4, superconductor films 3a and 4a, and metallic films 3b and 4b are shown.

As shown in FIG. 1A, in the dielectric block 1 having a substantially rectangular solid shape, the through-hole 2 having the inner surface electrode 3 formed on the inner surface thereof extends from one face of the block 1 to the opposite face thereof. The outer surface electrode 4 is formed on the outer surfaces of the dielectric block 1 excluding the outer surfaces having the openings of the through-hole 2. The length of the dielectric block 1 in the direction parallel to the through-hole 2 is preferably set at half the wavelength of a transmission signal. Thus, a half-wave dielectric resonator is formed.

The dielectric block 1 is made of a dielectric of which the dielectric constant has a negative temperature coefficient, that is, the dielectric constant increases as the temperature decreases. As the material, Ba(Mg, Ta)O₃, Ba(Sn, Mg, Ta)O₃, Ba(Mg, Nb)O₃, Ba(Zn, Nb)O₃, and the like are used.

As shown in FIGS. 1B and 1C, the inner surface electrode 3 is formed by lamination of a superconductor film 3a and a metallic film 3b. Similarly, the outer surface electrode 4 is formed by lamination of a superconductor film 4a and a metallic film 4b. Referring to the lamination method, first, the superconductor films 4a and 3a are formed on the outer surface of the dielectric block 1 and the inner surface of the through-hole 2. Thereafter, the metallic films 4b and 3b are formed on the surfaces of the superconductor films 4a and 3a, respectively. Referring to the thickness of the respective films, preferably, the superconductor films have a thickness of 0.2 to 10 μm, and the metallic films have a thickness of at least 1 μm.

As materials for the superconductor films 3a and 4a, Y₁Ba₂Cu₃Oₓ, (Bi, Pb)₂Sr₂Ca₂Cu₃Oₓ, Bi₂Sr₂Ca₁Cu₂Oₓ, and the like are preferably used. As materials for the metallic films 3b and 4b, Ag, Au, Pt, Cu, Al, and the like are preferably used.

The temperature dependence (temperature characteristic) of the resonance frequency of the dielectric resonator will be described with reference to FIGS. 2A and 2B, below.

FIG. 2A is a graph showing the temperature characteristic of the resonance frequency for a dielectric of which the temperature coefficient of the dielectric constant is zero. FIG. 2B is a graph showing the temperature characteristic of the resonance frequency for a dielectric of which the temperature coefficient of the dielectric constant is negative.

In FIGS. 2A and 2B, Tc is the transition temperature of a superconductor, T₁ is a temperature in the low temperature region at which the dielectric resonator is applied, and T2 is a temperature in the ordinary (high) temperature region at which the dielectric resonator is applied.

As shown in FIG. 2A, when the dielectric constant of the dielectric has a temperature coefficient of zero, the resonance frequency is increased on the lower temperature side with respect to the transition temperature as a boundary, while the resonance frequency is decreased on the higher temperature side. The reason is as follows.

First, the case wherein the electrode temperature is up to the transition temperature Tc, the conductivities of the superconductor films 3a and 4a are higher than those of the metallic films 3b and 4b. Thus, electric current concentrates on the superconductor films 3a and 4a. Therefore, the superconductor films 3a and 4a function as the main electrodes of the dielectric resonator. The dielectric resonator resonates in this condition. When the electrode temperature becomes the transition temperature Tc or higher, the conductivities of the superconductor films 3a and 4a are rapidly decreased to be lower than those of the metallic films 3b and 4b. Therefore, the electric current concentrates on the metallic films 3b and 4b, so that the metallic films 3b and 4b function as the main electrodes of the dielectric resonator. At this time, the superconductor films 3a and 4a hardly function as the electrodes, so that practically the resonance space (region) is increased, and correspondingly, the resonance frequency is reduced.

On the other hand, as described above, in the case where the dielectric block is made of a dielectric of which the dielectric constant is a negative temperature coefficient, the resonance frequency is reduced as the temperature decreases. Therefore, the temperature characteristic shown in FIG. 2B can be obtained by laminating the superconductor films and the metallic films on the surfaces of the dielectric block having a dielectric constant with a negative temperature coefficient (e.g., −24 ppm/K) to form the inner and outer surface electrodes.

As shown in FIG. 2B, the resonance frequency of the dielectric resonator can be set to be in a predetermined frequency range when the temperature of the device is in a predetermined range including the transition temperature Tc therein. Accordingly, for example, the resonance frequency at the operation ambience temperature T₁ on the lower temperature side and that T₂ on the higher temperature side can be made coincident with each other. Thus, the temperature dependencies of the resonance frequencies can be substantially completely cancelled out by each other in the wide temperature range (low temperature to ordinary temperature) including the transition temperature T_{c} therein. Thus, the dielectric resonator can be operated at a constant resonance frequency and a low loss.

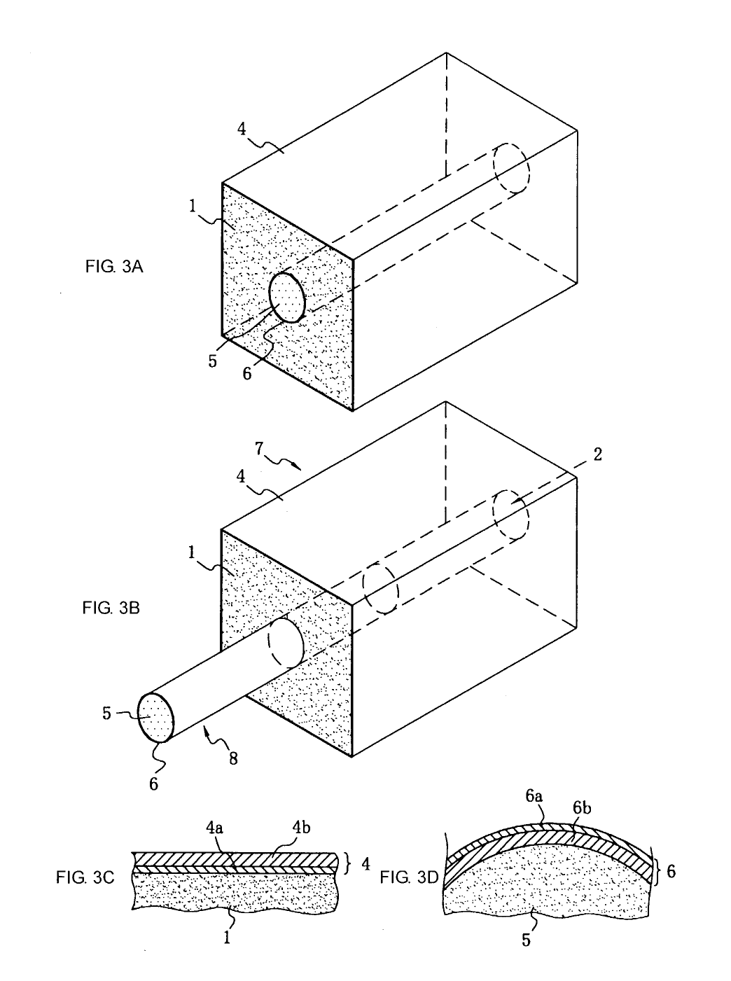

Hereinafter, the configuration of a dielectric resonator according to a second embodiment of the present invention will be descried with reference to FIGS. 3A to 3D.

FIG. 3A is a perspective view of the dielectric resonator. FIG. 3B is an exploded perspective view thereof. FIG. 3C is an enlarged cross-sectional view of the outer surface electrode of the dielectric resonator. FIG. 3D is an enlarged cross-sectional view of the inner surface electrode of the dielectric resonator.

In FIGS. 3A to 3D, the dielectric block 1, the through-hole 2, the electrode 4 formed on the outer surface of the dielectric block 1 (the outer surface electrode), a rod 5, an electrode 6 formed on the side surface of the rod 5, an external unit 7, an internal unit 8, superconductor films 4a and 6a, and metallic films 4b and 6b are shown. The rod 5 corresponds to the rod-shape member according to the present invention.

In the dielectric block 1 having a substantially rectangular solid shape, the through-hole 2 is formed so as to extend from one face of the block 1 to the opposite face thereof. The electrode (outer surface electrode) 4 is formed on the outer surface of the dielectric block 1 excluding the outer surfaces having the openings of the through-hole 2. The dielectric block 1 having the through-hole 2 and the electrode 4 formed on the outer surface of the dielectric block 1 constitute the external unit 7.

The electrode 6 is formed on the side surface of the rod 5 preferably having a length equal to the distance between the opening surfaces of the through-hole 2 in the dielectric block 1. The rod 5 and the electrode 6 formed on the side surface of the rod 5 constitute the internal unit 8.

The internal unit 8 is inserted into the through-hole 2 of the external unit 7, so that the electrode 6 functions as the inner surface electrode. The length of the dielectric block 1 in the direction parallel to the through-hole 2 of the external unit 7 is preferably set at half the wavelength of a transmission signal. Thus, a half-wave dielectric resonator is formed.

As shown in FIGS. 3C and 3D, the outer surface electrode 4 is formed by lamination of the superconductor film 4a and the metallic film 4b onto the surface of the dielectric block 1 in that order. Moreover, the electrode 6 is formed by lamination of the metallic film 6b and the superconductor film 6a onto the side surface of the 4 rod 5 in that order.

The dielectric block 1, the superconductor films 4a and 6a, and the metallic films 4b and 6b are the same as those described in the first embodiment. The rod 5 supports the electrode which acts as the inner surface electrode of the resonator. The dielectric material for the rod may be different from that for the dielectric block 1. Preferably, the dielectric material used for the rod has the same linear expansion coefficient as that constituting the dielectric block 1. Thus, when the temperature is changed, change of the interval between the electrodes 4 and 6 acts similarly to the change which would be obtained if the electrode 6 is provided on the inner surface of the through-hole 2 in the dielectric block 1.

According to the above-described configuration, the same advantages as those in the first embodiment can be obtained. That is, a dielectric resonator which has a substantially constant resonance frequency in a wide temperature range and a low loss can be provided.

The lamination process is simplified, since the electrode 6 as the inner surface electrode is formed on the side surface of the rod 5 constituting the internal unit 8. Accordingly, the high precision electrode can be easily formed and the characteristics of the dielectric resonator can be stabilized.

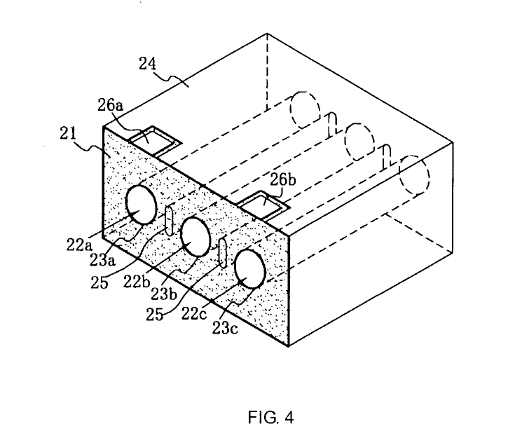

Hereinafter, the configuration of a dielectric filter according to a third embodiment of the present invention will be described with reference to FIG. 4.

FIG. 4 is a perspective view of the filter. In FIG. 4, a dielectric block 21, through-holes 22a to 22c, inner surface electrodes 23a to 23c formed on the inner surfaces of the through-holes 22a to 22c, an outer surface electrode 24 formed on the outer surface of the dielectric block 21, coupling holes 25 for electromagnetic coupling the adjacent inner surface electrodes, and input-output electrodes 26a and 26b as inputting-outputting means are shown.

The plural through-holes 22a to 22c each having a circular cross-section are formed in the dielectric block 21 having a substantially rectangular solid shape so as to extend from one side (the left-front side in FIG. 4) of the block 21 to the opposite side (the right-rear side in FIG. 4). The inner surface electrodes 23a to 23c are formed by sequential lamination of super conductor films and metallic films onto the inner surfaces of the through-holes 22a to 22c. The plural coupling holes 25 having an elliptic cross-section are formed between the through-holes 22a, 22b, and 22c, respectively.

The outer surface electrode 24 is formed on the outer surface of the dielectric block 21, that is, on the overall four sides of the dielectric block 21 excluding the sides having the openings of the through-holes 22a to 22c. The outer surface electrode 24 is formed by sequential lamination of a superconductor film and a metallic film onto the outer surface of the dielectric block 21.

The two input-output electrodes 26a and 26b are formed in such a manner as to be electrostatic-capacitance-coupled to the inner surface electrodes 23a and 23c, respectively.

The dielectric block 21, the inner surface electrodes 23a to 23c, and the outer surface electrode 24 are made of the same materials as those for the first embodiment and are formed in a manner similar to that for the first embodiment.

As described above, the inner surface electrodes 23a to 23c, the dielectric of the dielectric block 21, and the outer surface electrodes 24 constitute dielectric resonators, respectively. These dielectric resonators are electromagnetically coupled to each other through the coupling holes 25, and the resonators containing the inner surface electrodes 23a and 23c are coupled to the input-output electrodes 26a and 26b, respectively. Thus, as a whole, a dielectric filter is formed.

According to the above-described configuration, a dielectric filter having superior communication characteristics in which the resonance frequency can be kept substantially constant in a wide temperature range, and hence, a signal can be propagated at a low loss, can be provided.

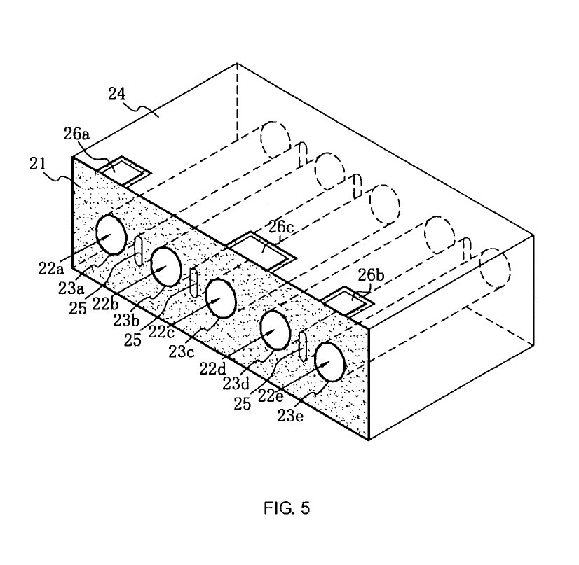

Hereinafter, a duplexer according to a fourth embodiment of the present invention will be described with reference to FIG. 5.

FIG. 5 is a perspective view of the duplexer. In FIG. 5, a dielectric block 21, through-holes 22a to 22e formed in the dielectric block 21, inner surface electrodes 23a to 23e formed on the inner surfaces of the through-holes 22a to 22e, respectively, an outer surface 24 formed on the outer surface of the dielectric block 1, coupling holes 25 for electromagnetically coupling adjacent inner surface electrodes to each other, and input-output electrodes 26a, 26b, and 26c to function as input-output means are shown.

The plural through-holes 22a to 22e each having a circular cross-section are formed in the dielectric block 21 having a substantially rectangular solid shape so as to extend from one side (the left-front side in FIG. 5) of the block 21 to the opposite side (the right-rear side in FIG. 5). The plural coupling holes 25 having an elliptic cross-section are formed between the through-holes 22a to 22e, respectively. The outer surface electrode 24 is formed on the outer surface of the dielectric block 21, that is, on the overall four sides of the dielectric block 21 excluding the sides having the openings of the through-holes 22a to 22e. The two input-output electrodes 26a and 26b are formed in such a manner as to be electrostatic-capacitance-coupled to the inner surface electrodes 23a and 23e, respectively. The input-output electrode 26c is formed so as to be electrostatic-capacitance-coupled to the inner surface electrodes 23c and 23d, respectively.

The dielectric block 21, the inner surface electrodes 23a to 23e, and the outer surface electrode 24 are made of the same materials as those for the first embodiment and are formed in a manner similar to that for the first embodiment.

As described above, the inner surface electrodes 23a to 23e and the dielectric block 21, and the outer surface electrode 24 constitute resonators, respectively. These resonators are electromagnetically coupled to each other through the coupling holes 25. The resonator containing the inner surface electrode 23a is coupled to the input-output electrode 26a, and the resonator containing the inner surface electrode 23c is coupled to the input-output electrode 26c. Thus, one filter is formed between the input-output electrodes 26a and 26c. Moreover, the resonator containing the inner surface electrode 23d is coupled to the input-output electrode 26c, and the resonator containing the inner surface electrode 23e is coupled to the input-output electrode 26b, so that another filter is formed between the input-output electrodes 26c and 26b. A duplexer may be composed by using one of these two filters as a transmission side filter and the other as a reception side filter.

According to the above-described configuration, a duplexer having superior communication characteristics in which the resonance frequency can be substantially kept constant in a wide temperature range, and thus, a signal can be propagated at a low loss can be easily formed.

Referring to another method of producing a duplexer, the duplexer may be formed by using two filters described in the third embodiment, adjusting the phase of one input-output electrode of each filter is phase-adjusted, and causing it to conduct.

The filter or the duplexer described above has a configuration in which the inner surface electrodes are formed on the inner surfaces of through-holes. On the other hand, the filter or the duplexer may be formed so as to have a configuration in which a rod having an electrode formed on the side face thereof is inserted into a through-hole of a dielectric block as shown in the dielectric resonator of FIG. 3. Moreover, a filter or duplexer comprising plural stage resonators may be formed by arranging plural dielectric resonators as shown in FIGS. 1 and 3 in a case, and coupling adjacent resonators to each other.

The resonators, the filters, and the duplexers according to the above-described embodiments are formed so as to have a circular cross-section. This is not restrictive. The cross-sections may be elliptical, oval, or polygonal. The cross-sections of the through-holes and the dielectric rod do not necessarily have to be the same.

Moreover, in the above-described embodiments, each electrode is a two-layer laminated electrode comprising a superconductor film and a metallic film. This is not restrictive. Multi-layer structures, and mixed-structures having metal dispersed in a superconductor film may be employed. It is indispensable that the electrode has a lower loss than metal at the superconduction transition temperature or lower, and exhibits a loss characteristic lower than the superconductor in the normal conducting state at the superconduction transition temperature or higher. For the dielectric, materials are selected which have a negative dielectric constant temperature coefficient and thereby the frequency−temperature characteristic of a resonator (filter) can be corrected.

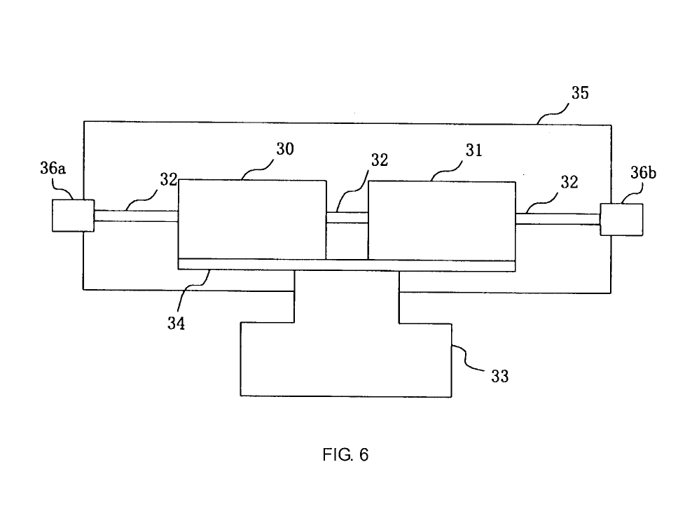

Hereinafter, a low temperature transmission-reception device according to a fifth embodiment of the present invention will be described with reference to FIG. 6.

FIG. 6 is a schematic view of the low temperature transmission-reception device. In FIG. 6, a filter 30, LNA 31 (low noise amplifier), a thermal insulation high frequency cable 32, a cooling device 33, a cooling stage 34, a vacuum thermal insulation case 35, and hermetic connectors 36a and 36b are shown.

The filter 30 and the LNA 31 are connected to each other by means of the thermal insulation high frequency cable 32, and are placed on the cooling stage 34. The cooling device 33 is connected to the cooling stage 34 to cool the cooling stage 34 to a predetermined temperature. The filter 30, the LNA 31, and the cooling stage 34 are disposed in the vacuum thermal insulation case 35, so that the filter 30 and the LNA 31 are continuously controlled to be maintained at a constant low temperature.

Moreover, the filter 30 is connected to the hermetic connector 36a, and also, the LNA 31 is connected to the hermetic connector 36b by means of the thermal insulation high frequency cable 32, respectively. The filter 30 and the LNA are connected to an external circuit via the hermetic connectors 36a and 36b, respectively.

A signal received from the external circuit via the hermetic connector 36a is transmitted to the filter 30 via the insulation high frequency cable 32. The filter 30 allows only a signal in a necessary frequency band to pass and transmits the signal to the LNA via the thermal insulation high frequency cable 32. The LNA amplifies the transmitted signal and outputs the signal to the external circuit in the next stage via the thermal insulation high frequency cable 32 and the hermetic connector 36b.

The cooling device 33 controls the temperature of the whole superconductor to be lower than the transition temperature, and thereby, the main electrodes for the filter become superconductor films. Thus, the conductor loss can be reduced and a reception device having superior communication characteristics can be can be formed.

As the filter shown in FIG. 6, the filter shown in FIG. 4 can be employed.

If the function of the cooling device 33 stops for some reason, the temperature of the whole device will increase. When the temperatures of the electrodes exceed the transition temperature, the metallic films function as the electrodes. Thus, the loss increases. However, the increment of the loss can be suppressed to be lower compared to the case in which all the electrodes are made of superconductor films, respectively. Moreover, the frequency characteristic of the filter can be kept substantially constant.

Furthermore, a transmission device, which comprises the combination of a filter and an amplifier, can be formed in the same manner as the above-described reception device.

According to this embodiment, the amplifier is connected to the output of the filter. Reversely, the amplifier may be connected to the input of the filter.

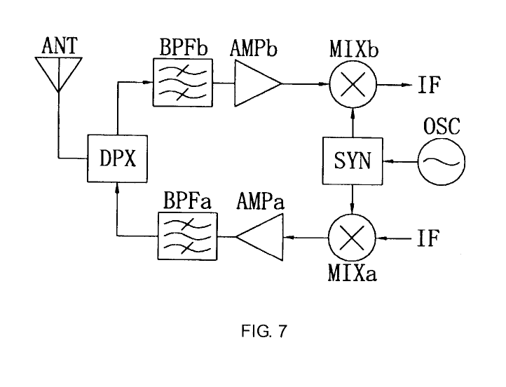

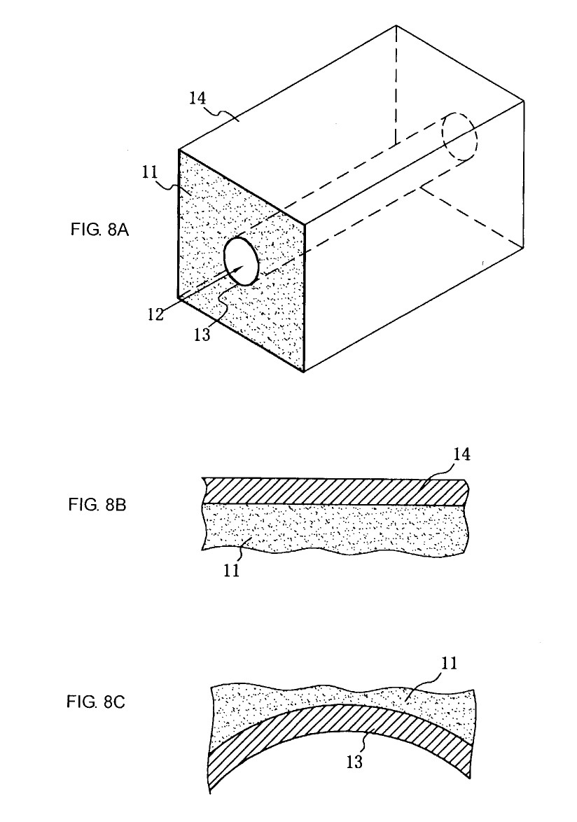

A communication device according to a sixth embodiment of the present invention will be described with reference to FIG. 7.

FIG. 7 is a block diagram of the communication device.

In FIG. 7, a transmission-reception antenna ANT, a duplexer DPX, band-pass filters BPFa and BPFb, amplifier circuits AMPa and AMPb, mixers MIXa and MIXb, an oscillator OSC, a synthesizer SYN, and an intermediate frequency signal IF are shown. The mixer MIXa modulates a frequency signal output from the synthesizer SYN with an IF signal. In the amplifier circuit, the signal is power-amplified. The band-pass filter BPFa passes only the signal present in the transmission frequency band. The signal is sent from the antenna ANT via the duplexer DPX. The bandpass filter BPFb passes only the signals present in the reception frequency band of signals output from the duplexer DPX. The amplifier circuit AMPb amplifies the signals output from the band-pass filter BPFb. The MIXb mixes a frequency signal output from the synthesizer SYN with a reception signal to form the intermediate frequency signal IF.

As the duplexer shown in FIG. 7, the duplexer having the configuration shown in FIG. 5, and the filter having the configuration shown in FIG. 4 may be employed. As the filters BPFa and BPFb, the filter having the configuration shown in FIG. 4 may be used. For the combination of the amplifier circuit AMPa and the band-pass filter BPFa and that of the band-pass filter BPFb and the amplifier circuit AMPb, the transmission-reception device having the configuration shown in FIG. 6 may be employed. Thus, a communication device having superior communication characteristics can be formed.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A resonator comprising:
a dielectric having a dielectric constant with a negative temperature coefficient; and
electrodes formed on the dielectric, the electrodes being composite electrodes made of a superconductor and a metal.

2. The resonator according to claim 1, wherein the electrodes are formed using the superconductor and the metal in such a manner that a resonance frequency at a transition temperature of the superconductor or lower is substantially equal to a resonance frequency at the transition temperature or higher.

3. A filter comprising:
at least two resonators defined in claim 1; and
inputting-outputting means coupled to predetermined resonators of the at least two resonators.

4. A composite filter device comprising at least two sets of filters, each filter containing the resonator defined in claim 1.

5. A resonator comprising:
a dielectric block having a dielectric constant with a negative temperature coefficient, and a through-hole formed in the dielectric block, the through-hole extending between opposite faces of the dielectric block;
an inner surface electrode formed on an inner surface of the through-hole; and
an outer surface electrode formed on outer surfaces of the dielectric block,
the inner surface electrode and the outer surface electrode being composite electrodes made of a superconductor film and a metallic film.

6. The resonator according to claim 5, wherein the inner surface electrode and the outer surface electrode are formed by sequential lamination of the superconductor film and the metallic film onto the inner surface of the through-hole and the outer surfaces of the dielectric block, respectively.

7. The resonator according to claim 5, wherein the inner and outer electrodes are formed using the superconductor film, and the metallic film in such a manner that a resonance frequency at a transition temperature of the superconductor film or lower is substantially equal to a resonance frequency at the transition temperature or higher.

8. A filter comprising:
at least two resonators defined in claim 5; and
inputting-outputting means coupled to predetermined resonators of the at least two resonators.

9. A duplexer comprising:
the filter defined in claim 6, the filter being at least one of a transmission filter provided between a transmission signal input port and a transmission-reception input-output port and a reception filter provided between the transmission-reception input-output port and a reception signal output port.

10. A composite filter device comprising at least two sets of filters, each filter containing the resonator defined in claim 5.

11. A resonator comprising:
an external unit comprising a dielectric block having a through-hole extending between two opposite faces of the dielectric block, and an outer electrode formed on the outer surface of the dielectric block; and
an internal unit comprising a rod member, and an inner electrode formed on a side surface of the rod member, the internal unit being inserted into the through-hole of the external unit,
the dielectric block having a dielectric constant with a negative temperature coefficient,
the inner electrode and the outer electrode being composite electrodes made of a superconductor film and a metallic film.

12. The resonator according to claim 11, wherein the rod member has a length substantially equal to a length of the through-hole.

13. The resonator according to claim 11, wherein the external unit is formed by sequential lamination of the superconductor film and the metallic film onto the outer surfaces of the dielectric block, and the internal unit is formed by sequential lamination of the metallic film and the superconductor film on the side surface of the rod member.

14. The resonator according to claim 11, wherein the inner and outer electrodes are formed using the superconductor film, and the metallic film in such a manner that a resonance frequency at a transition temperature of the superconductor film or lower is substantially equal to a resonance frequency at the transition temperature or higher.

15. A filter comprising:
at least two resonators defined in claim 11; and
inputting-outputting means coupled to predetermined resonators of the at least two resonators.

16. A filter comprising an external unit defined in claim 11, wherein the dielectric block is provided with plural through-holes for accommodating plural internal units, respectively,
wherein the plural internal units are arranged in respective ones of the plural through-holes to form plural resonators, and the filter is provided with inputting-outputting means coupled to predetermined resonators of the plural resonators.

17. A duplexer comprising:
the filter defined in claim 11, the filter being at least one of a transmission filter provided between a transmission signal input port and a transmission-reception input-output port and a reception filter provided between the transmission-reception input-output port and a reception signal output port.

18. A composite filter device comprising at least two sets of filters, each filter containing the resonator defined in claim 11.
